(19) United States
(12) Patent Application Publication
(10) Pub. No.: US 2015/0137735 A1
(43) Pub. Date: May 21, 2015

(54) Flash Charger for Electric/Hybrid Vehicles in Locations with Limited Electrical Service

(71) Applicant: John E Wacholtz, JR., Plano, TX (US)

(72) Inventor: John E Wacholtz, JR., Plano, TX (US)

(21) Appl. No.: 14/082,158

(22) Filed: Nov. 17, 2013

(51) Int. Cl. B60L 11/18; H02J 7/00

(52) U.S. Cl. CPC B60L 11/1824; H02J 7/0054
USPC 320/104

(57) ABSTRACT

A matrix of immobile batteries/battery packs automatically connected in optimized serial/parallel structure to provide optimum current at optimum potential to charge a mobile battery pack in the shortest practical time by direct DC connection. The immobile matrix, immobile battery packs or individual immobile batteries can be charge from limited electric service in the most efficient manner (optimize the AC to DC conversion) and at the optimum time (limit the cost of AC power or choose times of low load on the AC grid) unrestricted by the period of charging the mobile battery pack.

### BACKGROUND OF THE INVENTION

This invention relates to charging devices for mobile battery packs usually as part of Electric/Hybrid drive systems for vehicles.

A major drawback of present charging schemes for electric or plug-in-hybrid vehicles is the time required for fully charging the batteries with standard residential power (110 VAC, 100 or 200 AMP) usually from a single standard 30 Amp circuit. With the inefficiency of AC to DC chargers at voltages exceeding the RMS AC voltage this time can amount to one hour per kilowatt-hour (KWH) for the default charger. Faster schemes are available using 220 VAC service and the fastest currently use multiphase 440 VAC service which is almost never available in a residential environment to the dwelling that will house the vehicle. Both improved charging schemes require modifications to the dwellings wiring as well as higher service charges from the power provider.

Even if the enhanced power feeds to the dwelling were available and inexpensive this success brings with it the high risk of grid overload as the charging cycle for millions of vehicles would begin and end at roughly the same time. If the highest power chargers all require maximum power from the grid at the same time the consequences will be more dramatic than the worst mid-summer peak load.

Success of electrifying the independent transportation needs of a large population depends upon overcoming these limitations and large infrastructure requirements.

### BRIEF SUMMARY OF THE INVENTION

One or more banks of immobile batteries are automatically connected in serial and/or parallel to provide rapid charging to mobile battery packs on Electric/Hybrid vehicles by direct battery to battery connection. After the mobile battery pack has been charged, the immobile batteries are charged conventionally from available limited electrical service in an efficient manner at the time of least cost (presumably least load on the power grid).

### BRIEF DESCRIPTION OF THE SEVERAL VIEWS OF THE DRAWINGS

FIG. 1. Schematic of battery structure and switching.

FIG. 2. Charging switch and options.

FIG. 3. Charger switch and options.

### DETAILED DESCRIPTION OF THE INVENTION

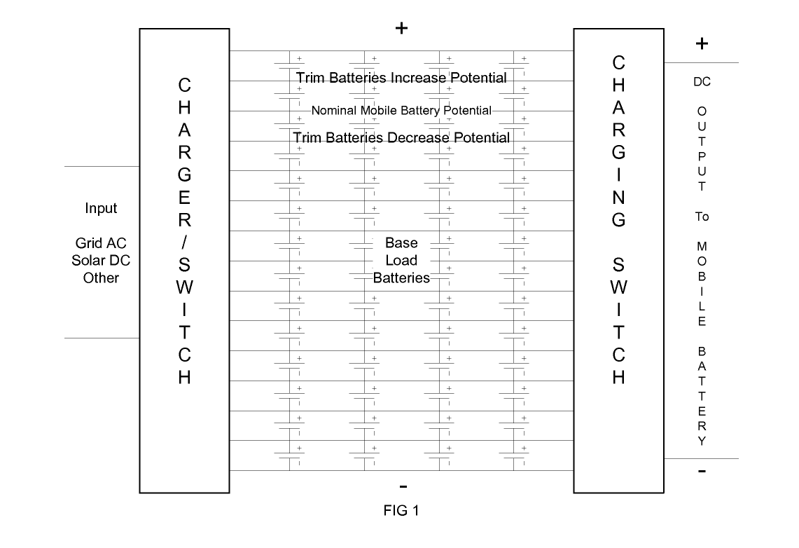

The invention consists of one or more banks of batteries connected by efficient switching matrices to provide high current DC charging by direct connection to the on-board batteries of an electric or plug-in-hybrid vehicle. The batteries within a bank or combined between banks will store, when charged, power equivalent to a fully charged battery pack of the target vehicle plus a margin to maintain a high charging rate to the full charge of the vehicle battery pack (FIG. 1).

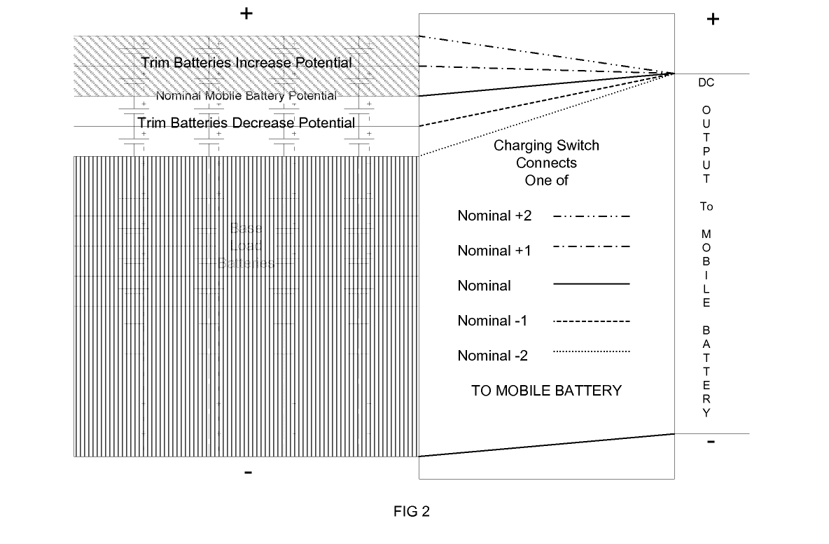

The charging switching matrix will connect the immobile batteries of the rapid charger in series sets to provide a DC potential exceeding that of the mobile batteries of the target vehicle to force the maximum acceptable current into the mobile batteries for the entire charging cycle. The battery matrix will also connect banks or groups of individual batteries in parallel at the nominal base potential to provide sufficient capacity to maintain the maximum acceptable current (FIG. 2).

As charge is transferred from the immobile batteries to the batteries on the vehicle the potential available from the immobile batteries will drop and the potential to overcome on the mobile batteries will rise. The switching matrix will add trim batteries or transfer base batteries into series connections to maintain the optimum DC potential for rapid charging and full transfer of charge to the batteries of the vehicle. Charging will cease when the vehicle batteries have been fully charged.

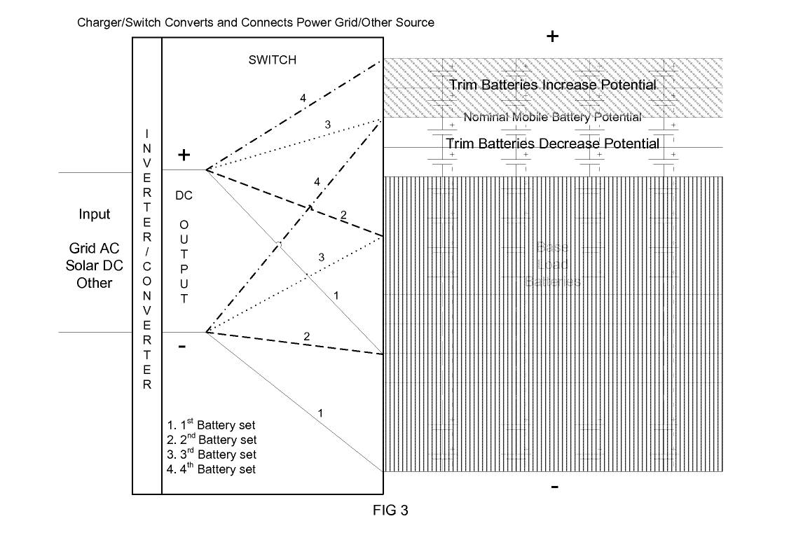

Upon full charge of the vehicle battery pack the system may completely disconnect the immobile batteries from any connection to the vehicle and recharge the immobile batteries in the most efficient manner available. A small AC-DC converter powered from the available AC service may remain connected to the mobile battery to hold the maximum charge in the vehicle batteries. The disconnected immobile batteries can be charged from the available AC/Solar/Other service over time including the time the vehicle is not connected to the charger (FIG. 3).

The switching matrix and one or multiple charger(s) will convert available AC/Solar DC/Other service power to charge the immobile batteries most efficiently in both time and inherent power loss. Time, in this case has two facets, the amount of time it takes to return the immobile batteries to sufficient charge to rapidly charge the vehicles battery pack again and the time at which the commercial power grid has power available at the least cost to the consumer and in infrastructure load.

Immobile battery banks or groups of individual batteries connected directly to the batteries aboard the target vehicle provide the most efficient way to transfer charge from one set of batteries to another. Losses will be from the heat generated by the high currents through the inherent resistance within the batteries and connections. No particular battery technology is required for the immobile batteries since the batteries do not have to be carried within a vehicle. Optimization for low internal resistance and deep power drain over many cycles is desirable.

Using multiple charging circuits to charge many subsets of the immobile batteries maximizes the use of limited AC service to speed the return of rapid charge capability. The allowed separation of the vehicle charging cycle from the time requiring grid power allows the spread of power demand to times of lower power grid usage. Separate controllers can optimize the time of charging based upon other dwelling requirements, cost of power by usage time, other demands on the limited available power, and power grid condition, if control inputs are available.

When in place and charged the immobile batteries will also be available for other uses. Vehicle battery packs hold from 17 KWH of energy to significantly over 110 KWH. To fully rapid charge these requires from 20 KWH to 150 KWH of immobile battery capacity. A normal residential dwelling in the USA requires from 1,000 KWH to 3,000 KWH plus of power per month. There are about 27 to 31 days in a month so even a relatively high usage residence uses just over 100 KWH per day. Even the smallest collection of batteries available for vehicle charging could provide several hours of service to the residence in a power emergency or, with proper coordination, to mitigate the requirement for rolling blackouts by separating some residences from the grid without effective residential power loss.

1. One or more banks of fully charged immobile batteries and/or individual batteries (immobile battery matrix) of power storage capacity and potential greater than the target mobile battery pack, when connected in an optimum serial/parallel matrix, will provide optimum rapid charging to the target mobile battery pack by direct connection of the immobile battery matrix to the mobile battery pack, without connection to any outside power source.

2. When the mobile battery pack is connected and fully charged or is disconnected, the immobile battery matrix can be charged as a whole or in separate groups or batteries at rates compatible with available limited electric service and at times of choice (lower cost or less load on the power grid).

3. The structure of direct battery to battery transfer of power when charging the mobile battery pack and separately charging the immobile batteries/packs at an optimum time and in an efficient manner not linked to the mobile charging time allows optimization of use of limited electric service, limits the requirement for specific battery characteristics, and allows for the least destructive charge cycle for the immobile batteries/packs.
